(19) United States
(12) Patent Application Publication
(10) Pub. No.: US 2026/0290873 A1
(43) Pub. Date: Sep. 24, 2026

(54) ULTRA-HIGH-SPEED DUAL CUTTING SYSTEM FOR SECONDARY BATTERY ELECTRODE PLATE AND ULTRA-HIGH-SPEED DUAL CUTTING METHOD THEREFOR

(71) Applicant: MPLUS CORP., Cheongju-si (KR)

(72) Inventors: Jong Sung KIM, Seongnam-si (KR); Kang Ho KO, Seoul (KR); Sung Moon KIM, Cheongju-si (KR)

(73) Assignee: MPLUS CORP., Cheongju-si (KR)

(21) Appl. No.: 19/230,048

(22) Filed: Jun. 5, 2025

(30) Foreign Application Priority Data
Mar. 24, 2025 (KR) 10-2025-0037613

(51) Int. Cl. H01M 10/04; B26D 1/04; B26D 7/06

(52) U.S. Cl. CPC H01M 10/0404; B26D 1/04; B26D 7/0625

(57) ABSTRACT

The purpose of the present invention is to provide an ultra-high-speed dual cutting system for secondary battery electrode plates with a feeding correction function. A configuration of the present invention comprises a feeding roller 140 and a conveyor capable of feeding the electrode plate along a feeding line of the main support frame 110 between the cutters during cutting of the electrode plate by the dual cutter, and a feeding correction unit mounted to the main support frame 110. The present invention enables ultra-high-speed dual cutting of the electrode plate because the electrode plate is fed by the main components, the conveyor and the feeding roller, to the dual cutter, that is, between the first upper cutter and the first lower cutter and the second upper cutter and the second lower cutter of the first cutting unit and the second cutting unit, and in this state, the first upper cutter and the second upper cutter of the first cutting unit and the second cutting unit simultaneously descend to perform dual cutting by simultaneously cutting both sides of the electrode plate by the first upper cutter and the first lower cutter and the second upper cutter and the second lower cutter.

### CROSS-REFERENCE TO RELATED APPLICATIONS

This application claims priority from Korean Patent Application No. 10-2025-0037613, filed on Mar. 24, 2025, in the Korean Intellectual Property Office, the disclosure of which is incorporated herein by reference in its entirety.

### BACKGROUND

### 1. Field

The present invention relates to an ultra-high-speed dual cutting system for secondary battery electrode plates with a feeding correction function and an ultra-high-speed dual cutting method for secondary battery electrode plates, and more particularly, to an ultra-high-speed dual cutting system for secondary battery electrode plates with a feeding correction function implemented to enable a fast electrode feeding speed and rapid electrode cutting operation and an ultra-high-speed dual cutting method for secondary battery electrode plates thereby.

### 2. Description of Related Art

A secondary battery is made by stacking a separator on a bottom, an anode plate thereon, a separator on the anode plate, a cathode plate on the separator, an anode plate again on an upper surface of the separator on the cathode plate, and alternately stacking a separator and a cathode plate sequentially.

Meanwhile, to manufacture a secondary battery, while supplying a rolled electrode plate along a feeding line, a notching unit notches the electrode plate to form a tab, a cutter unit cuts the tab-formed electrode plate to make a rectangular electrode plate, and after completing a vision inspection of the rectangular electrode plate by a vision unit, the rectangular electrode plate is transported by operation of a transport belt to be loaded in a stack magazine.

Here, while supplying along the feeding line, a notching unit notches the electrode plate to form a tab, a cutter unit cuts the tab-formed electrode plate to form a rectangular electrode plate, and an electrode plate feeding cutting unit is required for feeding and cutting the electrode plate to make the rectangular electrode plate.

A conventional sub-feeding unit operates such that a sub-feeding roller moves up/down by a motor and cam drive, a driving roller operates in contact with a transport belt, and the sub-feeding roller rotates to transport the electrode plate after pressing the electrode plate.

However, conventionally, there is a problem that the electrode feeding speed is relatively slow, so the electrode cutting operation is slowed down to the same extent as the electrode feeding speed, which is disadvantageous in terms of productivity, and the production operation of the production line is also slow, which is also a disadvantageous problem in terms of cutting operation delay and productivity of the electrode plate.

### PRIOR ART REFERENCES

### Patent Documents

Korean Patent Publication No. 10-2013-0048419 (Published on May 10, 2013)
Korean Utility Model Publication No. 20-2015-0003358 (Published on Sep. 11, 2015)
Korean Patent Registration No. 10-1096773 (Registered on Dec. 14, 2011)
Korean Patent Registration No. 10-0251078 (Registered on Jan. 10, 2000)

### BRIEF SUMMARY

The purpose of the present invention is to provide an ultra-high-speed dual cutting system for secondary battery electrode plates with a feeding correction function and an ultra-high-speed dual cutting method for secondary battery electrode plates, which realize a multi-feeding function and a feeding correction function of an electrode plate to enable a fast electrode feeding speed and a rapid electrode cutting operation, and further, are desirable in terms of productivity.

According to the present invention for solving the above problem, there is provided an ultra-high-speed dual cutting system for secondary battery electrode plates with a feeding correction function, comprising a dual cutter provided on a main support frame 110 to cut a secondary battery electrode plate, and a feeding roller 140 and a conveyor capable of feeding the electrode plate along a feeding line of the main support frame 110 between the cutters during dual cutting of the electrode plate by the dual cutter.

The dual cutter comprises a first cutting unit 120 and a second cutting unit 130 supported by the main support frame 110, wherein the first cutting unit 120 comprises a first cutting support bracket 122 mounted to the main support frame 110 via a first vertical rotation shaft 209, a first cutting connection bracket 124 mounted to the first cutting support bracket 122 via a first horizontal hinge 123, a first upper cutter 125 mounted to the first cutting connection bracket 124, a first lower cutter 126 supported by the main support frame 110 with an inner surface closely contacting an inner surface of the first upper cutter 125, and a first cutting adhesion cylinder 233 mounted to the main support frame 110 with a cylinder rod pressing the first cutting support bracket 122 downward to rotate the first cutting support bracket 122 toward the first lower cutter 126 based on the first horizontal hinge 123 connected to the main support frame 110, and the second cutting unit 130 comprises a second cutting support bracket 132 mounted to the main support frame 110 via a second vertical rotation shaft 219 and disposed at a position facing the first cutting support bracket, a second cutting connection bracket 134 mounted to the second cutting support bracket 132 via a second horizontal hinge 133, a second upper cutter 135 mounted to the second cutting connection bracket 134, a second lower cutter 136 supported by the main support frame 110 with an inner surface closely contacting an inner surface of the second upper cutter 135, and a first cutting adhesion cylinder 233 mounted to the main support frame 110 with a cylinder rod pressing the second cutting support bracket 132 downward to rotate the second cutting support bracket 132 toward the second lower cutter 136 based on the second horizontal hinge 133 connected to the main support frame 110.

The ultra-high-speed dual cutting system for secondary battery electrode plates further comprises a first cutting operation unit and a second cutting operation unit provided on the main support frame 110, wherein the first cutting operation unit comprises a first upper cutter lifting cam 162 rotatably provided on the main support frame 110, a first cam drive motor 164 with a motor shaft connected to the first upper cutter lifting cam 162, a pair of left and right first levers 165 with base ends relatively rotatably coupled to the first upper cutter lifting cam 162, a pair of left and right first lifting operation rods 166 with lower ends connected to front ends of the pair of first levers 165 via a rod end bearing REB, and a first upper cutting support bracket 167 connected to upper ends of the pair of first lifting operation rods 166 via a rod end bearing REB and connected to the first cutting support bracket 122 supporting the first upper cutter 125, and the second cutting operation unit comprises a second upper cutter lifting cam 172 rotatably provided on the main support frame 110, a second cam drive motor 174 with a motor shaft connected to the second upper cutter lifting cam 172, a pair of left and right second levers 175 with base ends relatively rotatably coupled to the second upper cutter lifting cam 172, a pair of left and right second lifting operation rods 176 with lower ends connected to front ends of the pair of second levers 175 via a rod end bearing REB, and a second upper cutting support bracket 177 connected to upper ends of the pair of second lifting operation rods 176 via a rod end bearing REB and connected to the second cutting support bracket 132 supporting the second upper cutter 135.

A stripper 180 is mounted on the main support frame 110 to be capable of lifting, and is configured such that the stripper 180 lifts during lifting of the first upper cutting support bracket 167 and the first upper cutter 125 and lifting of the second upper cutting support bracket 177 and the second upper cutter 135.

The ultra-high-speed dual cutting system for secondary battery electrode plates further comprises a feeding correction unit supported by the main support frame 110, wherein the feeding correction unit comprises a first feeding correction unit 200 and a second feeding correction unit 210, and the first feeding correction unit 200 comprises a first correction drive motor 202 mounted to the main support frame 110, a first rotating body 203 (lower cutter unit) coupled to the main support frame 110 via a first center hinge 208FCH, a first correction drive pulley 204 coaxially coupled to a motor shaft of the first correction drive motor 202, a first correction driven pulley 205 rotatably mounted to the first rotating body 203, a first correction belt 206 coupled to the first correction drive pulley 204 and the first correction driven pulley 205, a first correction ball screw 207 coaxially coupled to a center of the first correction driven pulley 205, a first correction ball screw nut 208 coupled to an outer peripheral surface of the first correction ball screw 207 and with an upper end coupled to the first rotating body 203 via a hinge, and a first vertical rotation shaft 209 that rotatably couples the first upper cutting support bracket 167 connected to the first cutting support bracket 122 supporting the first upper cutter 125 to the main support frame 110 in a horizontal direction, and the second feeding correction unit 210 comprises a second correction drive motor 212 mounted to the main support frame 110, a second rotating body 213 (lower cutter unit) coupled to the main support frame 110 via a second center hinge 208SCH, and a second correction drive pulley 214 coaxially coupled to a motor shaft of the second correction drive motor 212.

The second feeding correction unit 210 further comprises a second correction driven pulley 215 rotatably mounted to the second rotating body 213, a second correction belt 216 coupled to the second correction drive pulley 214 and the second correction driven pulley 215, a second correction ball screw 217 coaxially coupled to a center of the second correction driven pulley 215, a second correction ball screw nut 218 coupled to an outer peripheral surface of the second correction ball screw 217 and with an upper end coupled to the second rotating body 213 via a hinge, and a second vertical rotation shaft 219 that rotatably couples the second upper cutting support bracket 177 connected to the second cutting support bracket 132 supporting the second upper cutter 135 to the main support frame 110 in a horizontal direction.

The conveyor comprises a conveyor belt 152 that travels in an endless track on an electrode feeding line of the main support frame 110, wherein the conveyor belt 152 travels in the endless track to feed the electrode plate, and the feeding roller 140 is disposed above the electrode plate and configured to feed the electrode plate together with the conveyor belt 152.

The conveyor belt 152 comprises a suction belt having a plurality of suction holes penetrating upper and lower surfaces.

A plurality of the conveyor belts 152 are arranged side by side in a left-right width direction of the main support frame 110.

A plurality of the feeding rollers 140 are rotatably mounted to the main support frame 110 and arranged side by side in the left-right width direction of the main support frame 110, a feeding roller up-down drive motor 140UDM is mounted to the main support frame 110, a feeding roller up-down cam 140UDC is coupled to a motor shaft of the feeding roller up-down drive motor 140UDM, a feeding roller support frame 140RSF capable of lifting is coupled to the feeding roller up-down cam 140UDC and the main support frame 110, a plurality of guide rollers 143 are rotatably coupled to the feeding roller support frame 140RSF, an auxiliary feeding conveyor belt 140SCV traveling in an endless track is coupled to outer peripheral surfaces of the plurality of guide rollers 143, the auxiliary feeding conveyor belt 140SCV is coupled via an outer peripheral surface of an auxiliary feeding drive roller 140SCDR connected to a motor shaft of an auxiliary feeding belt drive motor 140SVM and outer peripheral surfaces of the plurality of guide rollers 143 in a vertically standing state, and is configured to travel in the endless track via the outer peripheral surfaces of the auxiliary feeding conveyor belt 140SCV and the plurality of guide rollers 143 according to driving of the auxiliary feeding belt drive motor 140SVM, a plurality of the feeding rollers 140 are coupled to the feeding roller support frame 140RSF via a roller shaft coupled at a center, the plurality of feeding rollers 140 are configured to be disposed above the feeding conveyor belt 152, and the feeding roller support frame 140RSF is provided with a plurality of tension rollers 144.

The ultra-high-speed dual cutting system for secondary battery electrode plates further comprises a first cutting adhesion drive unit and a second cutting adhesion drive unit that closely contact the first upper cutter 125 and the second upper cutter 135 to the first lower cutter 126 and the second lower cutter 136, respectively, wherein the first cutting adhesion drive unit comprises a first cutting adhesion cylinder 223 mounted to the first cutting support bracket 122 with a cylinder rod disposed in a vertical direction, and a first cutter adhesion operation bracket 224 provided on the first cutting connection bracket 124 connected to the first cutting support bracket 122 via the first horizontal hinge 123 and disposed at a position capable of being pressed by the cylinder rod of the first cutting adhesion cylinder 223, and the second cutting adhesion drive unit comprises a second cutting adhesion cylinder 233 mounted to the second cutting support bracket 132 with a cylinder rod disposed in a horizontal direction, and a second cutter adhesion operation bracket 234 provided on the main support bracket and disposed at a position capable of being pressed by the cylinder rod of the second cutting adhesion cylinder 233.

According to the present invention, there is provided an ultra-high-speed dual cutting method for secondary battery electrode plates using an ultra-high-speed dual cutting system for secondary battery electrode plates with a feeding correction function, comprising a dual cutter for cutting a secondary battery electrode plate, and a feeding roller 140 and a conveyor capable of feeding the electrode plate between the cutters during cutting of the electrode plate by the dual cutter, the method comprising an electrode feeding step of feeding the electrode plate to be cut along a feeding line by the feeding roller 140 and the conveyor, and an electrode dual cutting step of cutting the electrode plate fed along the feeding line using the dual cutter.

### Effects of the Invention

The present invention enables ultra-high-speed dual cutting of the electrode plate because the electrode plate is fed by the main components, the conveyor and the feeding roller, to the dual cutter, that is, between the first upper cutter and the first lower cutter and the second upper cutter and the second lower cutter of the first cutting unit and the second cutting unit, and in this state, the first upper cutter and the second upper cutter of the first cutting unit and the second cutting unit simultaneously descend to perform dual cutting by simultaneously cutting both sides of the electrode plate by the first upper cutter and the first lower cutter and the second upper cutter and the second lower cutter. In addition, the present invention has an effect of preventing cutting defects of the electrode plate (perpendicularity defects of the electrode plate) because even if a feeding misalignment phenomenon occurs during electrode feeding, the feeding misalignment of the electrode plate is corrected to cut the electrode plate.

### BRIEF DESCRIPTION OF THE DRAWINGS

### Brief Description of the Drawings

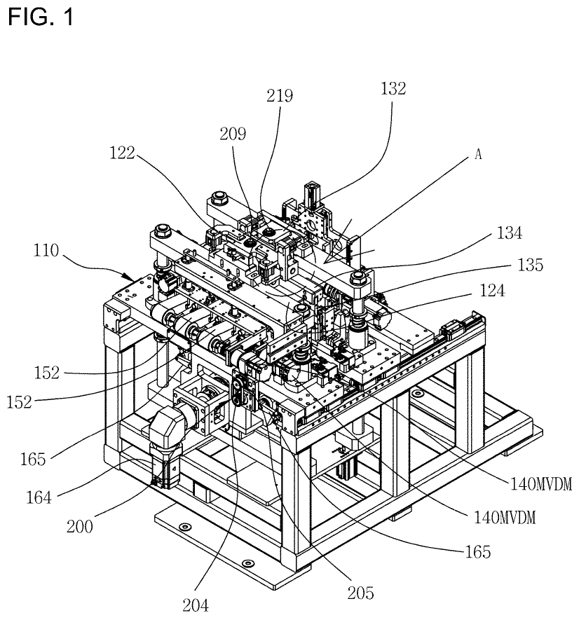

FIG. 1 is a left side perspective view of the ultra-high-speed dual cutting system for secondary battery electrode plates with a feeding correction function according to the present invention.

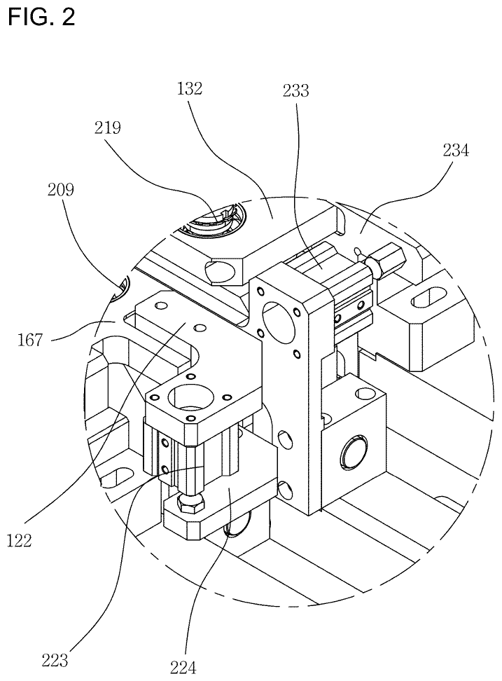

FIG. 2 is an enlarged view of part A of FIG. 1, showing an enlarged structure of the main components, the first cutting adhesion cylinder and the second cutting adhesion cylinder.

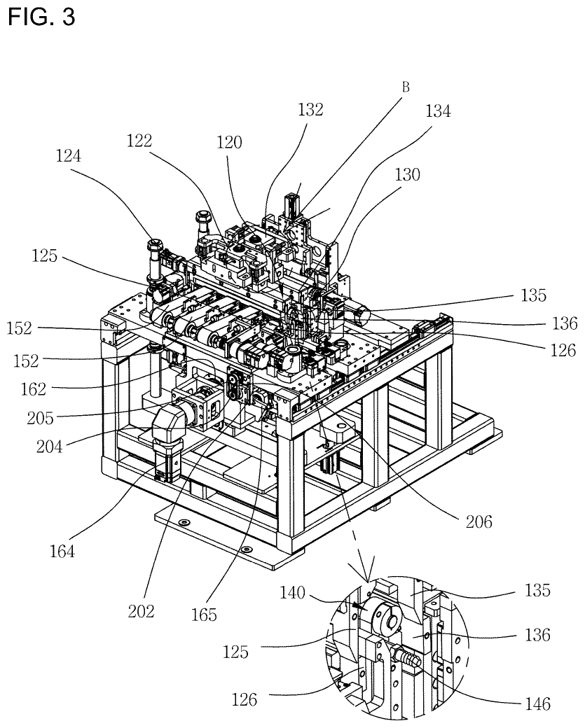

FIG. 3 is a perspective view showing an enlarged view of the main components, the feeding roller and the suction pipe, shown in FIG. 1, and

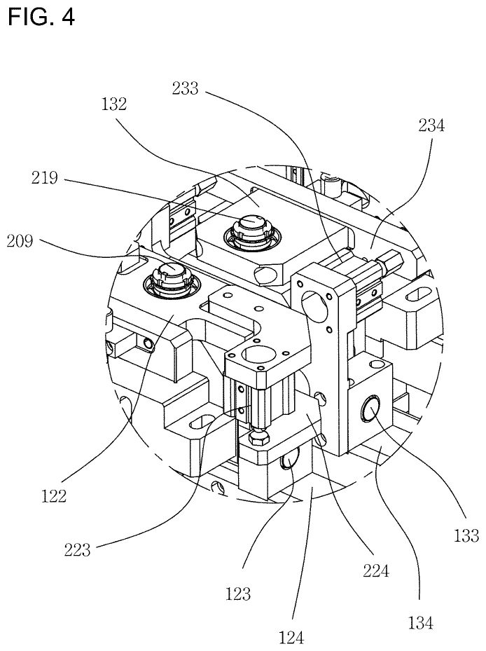

FIG. 4 is an enlarged view of part B of FIG. 3.

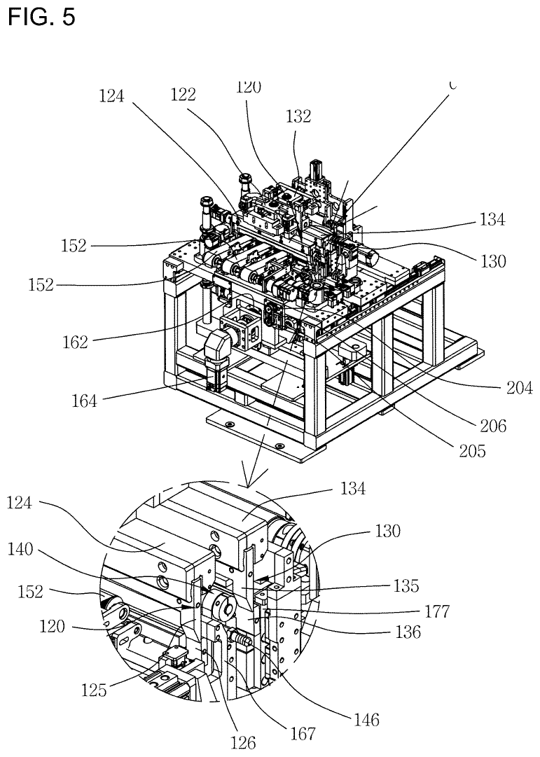

FIG. 5 is a left side perspective view showing an enlarged view of the main component, the dual cutter part, of the ultra-high-speed dual cutting system for secondary battery electrode plates with a feeding correction function according to the present invention, and

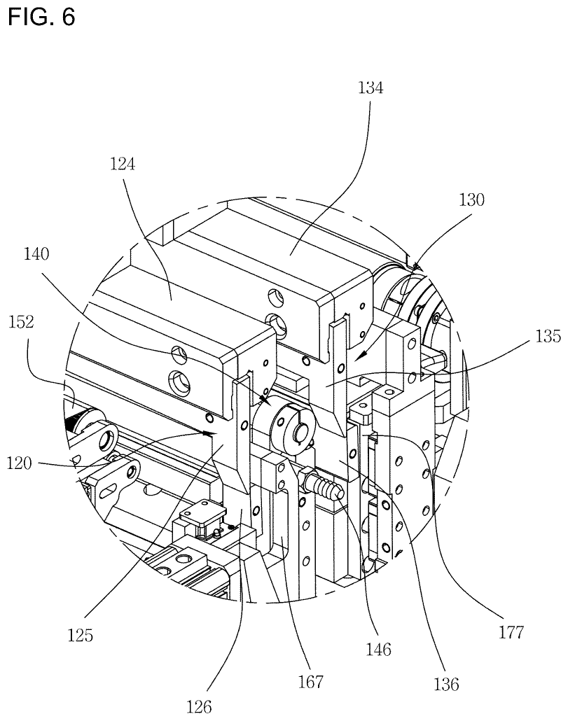

FIG. 6 is an enlarged view of part C of FIG. 5.

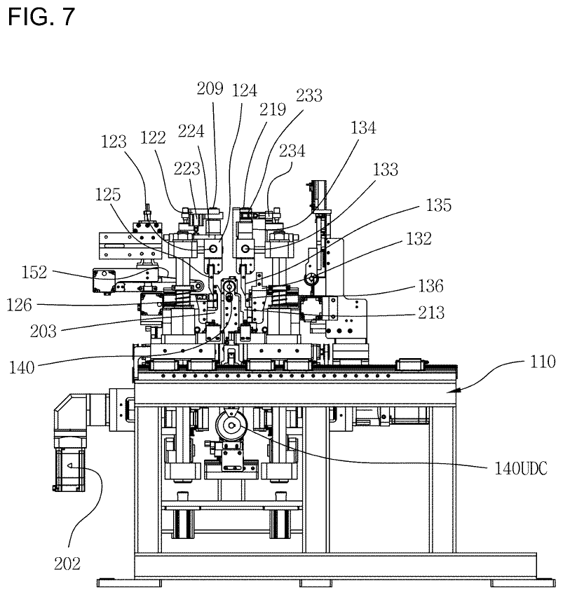

FIG. 7 is a right side view of the ultra-high-speed dual cutting system for secondary battery electrode plates with a feeding correction function according to the present invention.

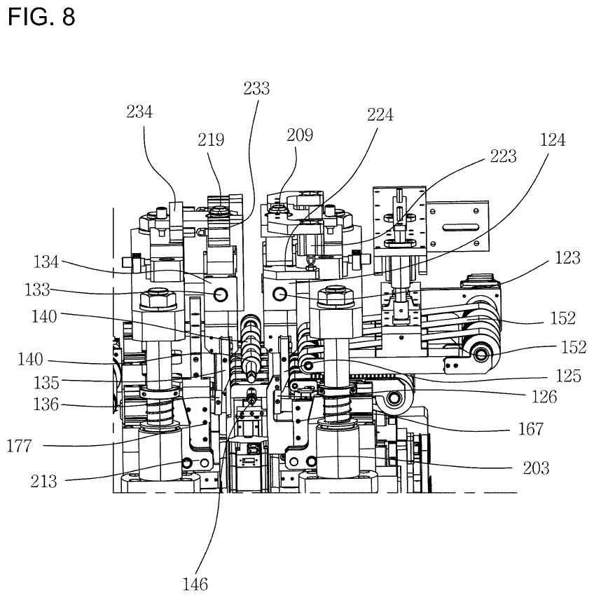

FIG. 8 is a perspective view showing an enlarged view of the structure of the main components, the feeding roller and the conveyor, of the ultra-high-speed dual cutting system for secondary battery electrode plates with a feeding correction function according to the present invention from the right side.

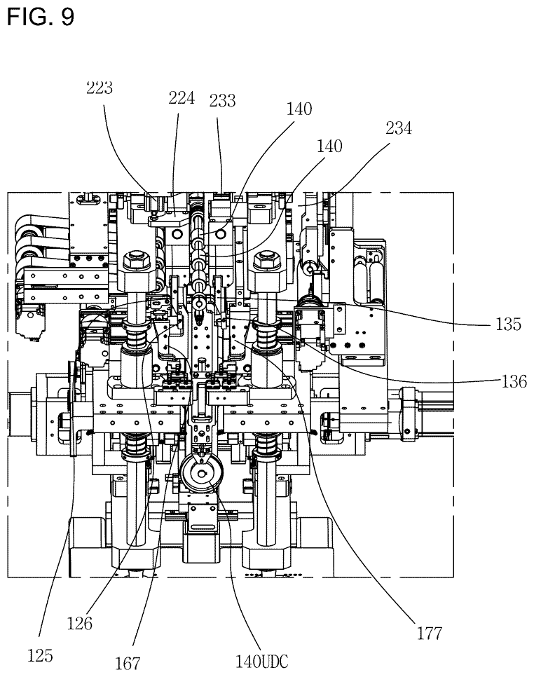

FIG. 9 is a perspective view showing an enlarged view of the structure of the main components, the feeding roller and the conveyor, from the left side.

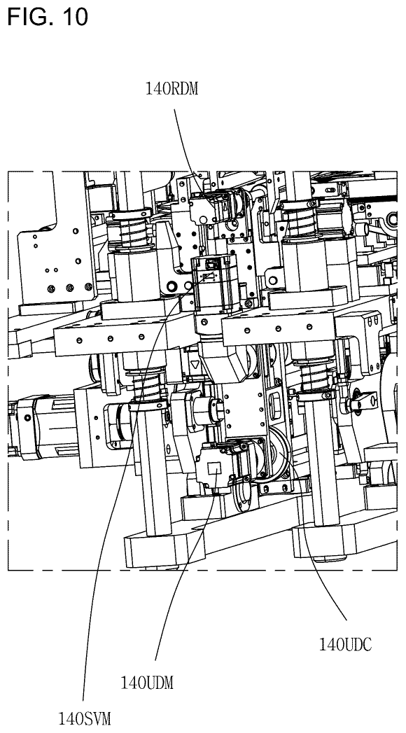

FIG. 10 is a view showing an enlarged view of the structure of the other main components, the feeding roller, the feeding roller drive motor, the auxiliary feeding belt drive motor, the feeding roller up-down drive motor, and the feeding roller up-down cam part, of the ultra-high-speed dual cutting system for secondary battery electrode plates with a feeding correction function according to the present invention.

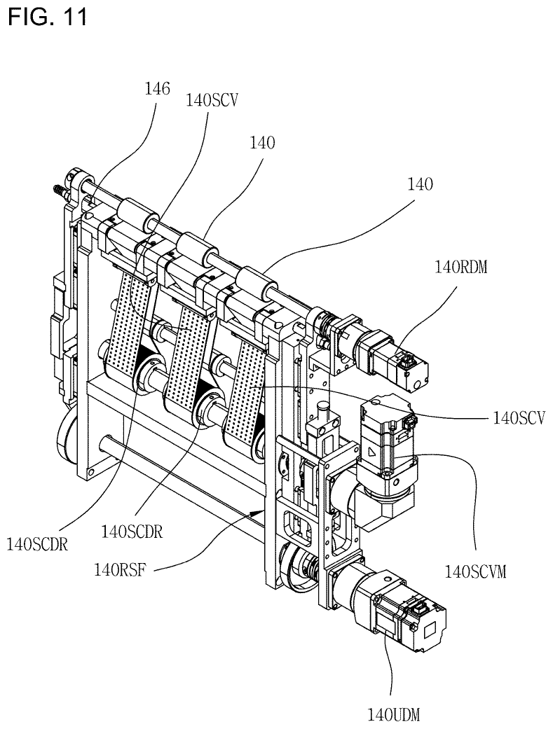

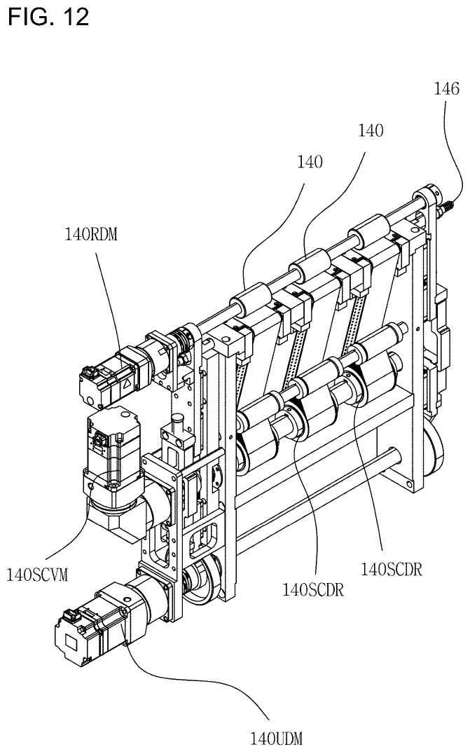

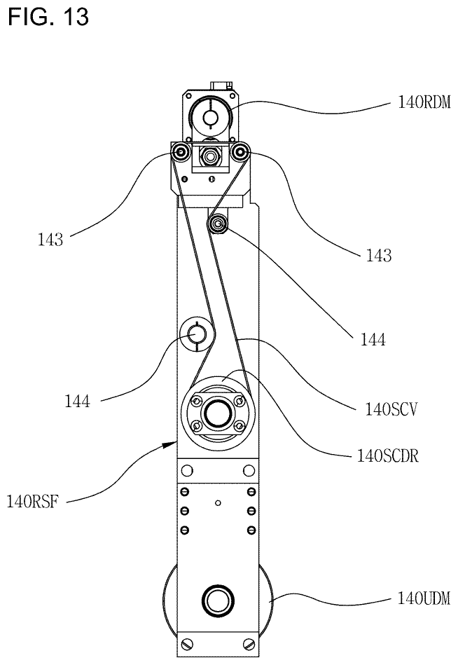

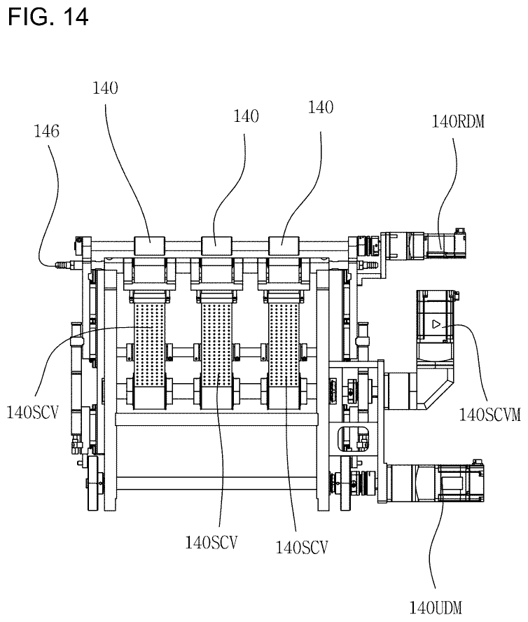

FIG. 11 is a front perspective view showing the structure of the other main components, the feeding roller, the feeding roller drive motor, the auxiliary feeding belt drive motor, and the feeding roller up-down drive motor part, of the present invention, FIG. 12 is a rear perspective view of FIG. 11, FIG. 13 is a right side view of FIG. 11, and FIG. 14 is a front view of FIG. 11.

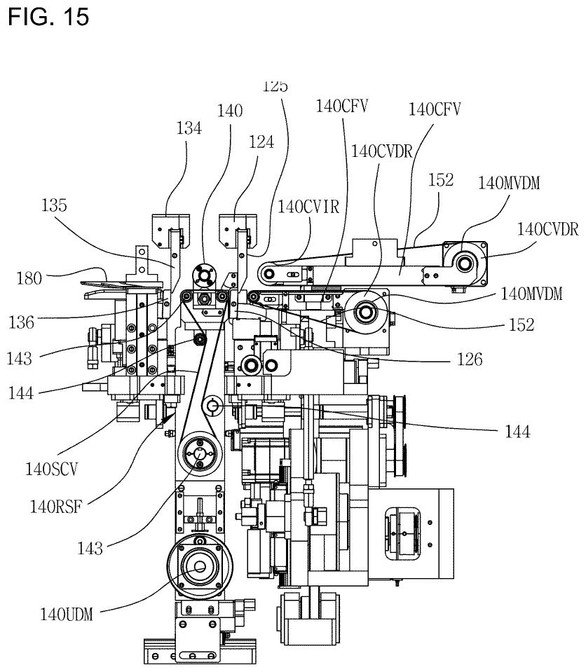

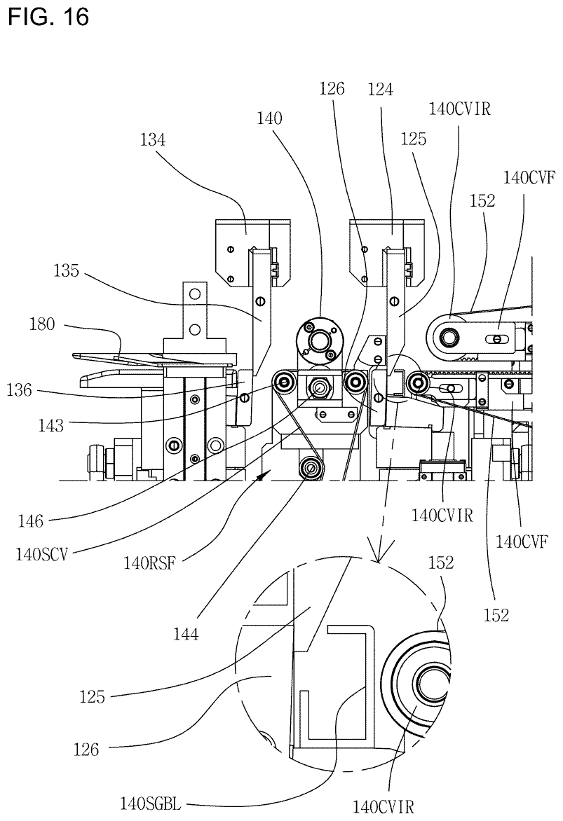

FIG. 15 is a right side view showing an enlarged view of the structure of the main components, the dual cutter, the auxiliary feeding conveyor belt, the tension roller, and the feeding roller up-down cam part, of the ultra-high-speed dual cutting system for secondary battery electrode plates with a feeding correction function according to the present invention, and FIG. 16 is an enlarged view of the main part of FIG. 15.

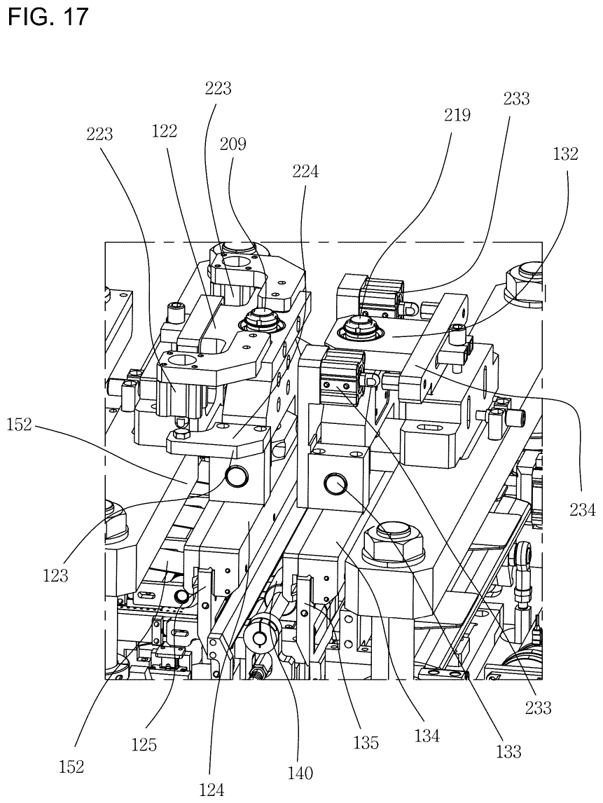

FIG. 17 is a view showing an enlarged view of the structure of the main components, the first cutting adhesion cylinder, the second cutting adhesion cylinder part, and the dual cutter part, of the present invention.

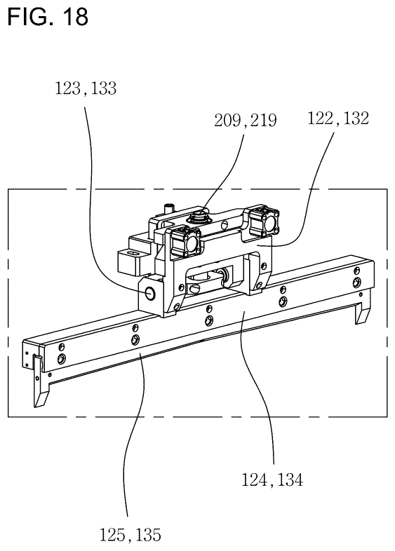

FIG. 18 is a view schematically showing the structure of the main components, the first upper cutter and the second upper cutter part, constituting the dual cutter of the ultra-high-speed dual cutting system for secondary battery electrode plates with a feeding correction function according to the present invention.

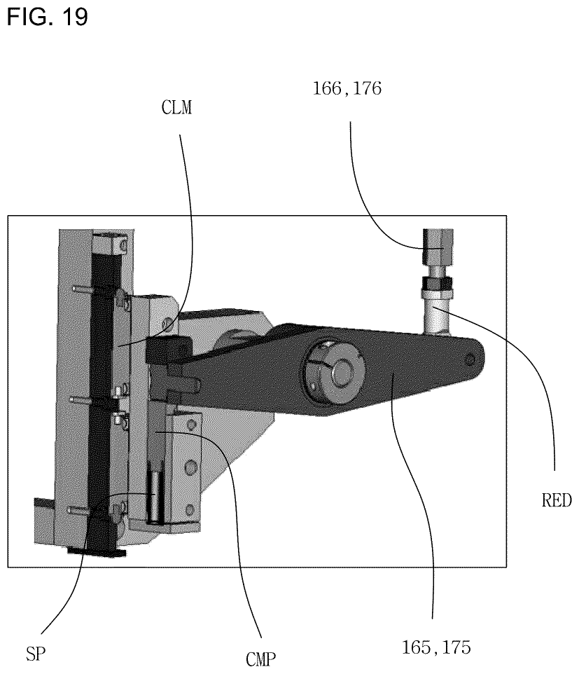

FIG. 19 is a half-cut perspective view schematically showing the structure of the other main components, the first lever, the second lever, the cam-side LM guide, the cam push device, and the spring, of the present invention.

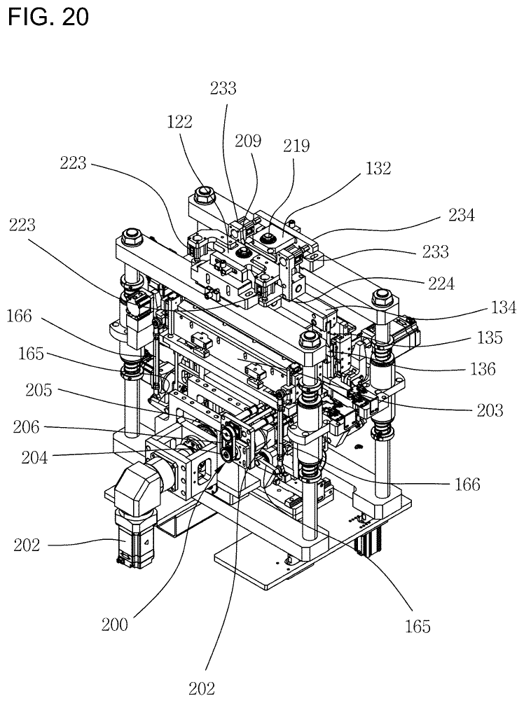

FIG. 20 is a right side perspective view schematically showing the structure of the main component, the first feeding correction unit, of the present invention.

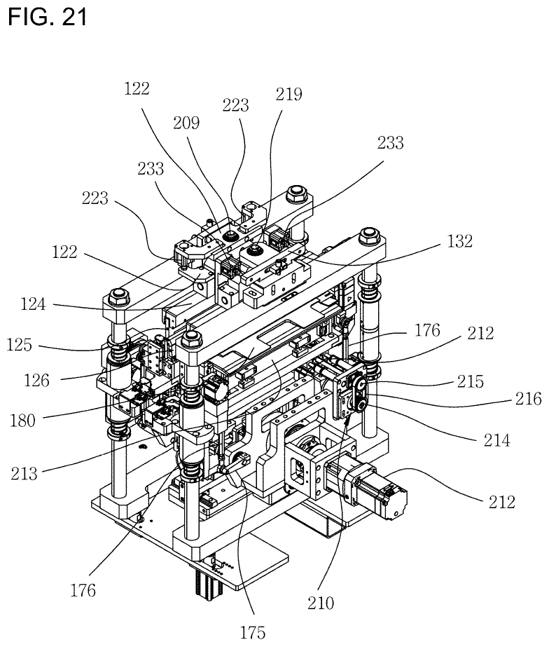

FIG. 21 is a right side perspective view schematically showing the structure of the main component, the second feeding correction unit, of the present invention.

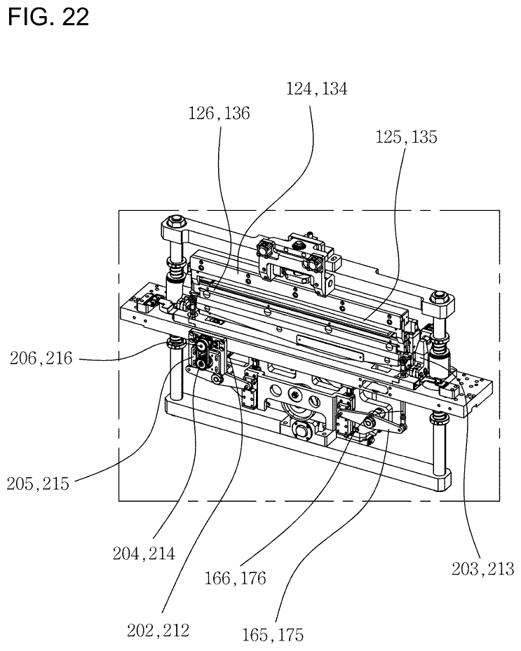

FIG. 22 is a view schematically showing the structure of the main components, the stripper and the electrode plate perpendicularity defect adjustment unit, of the present invention.

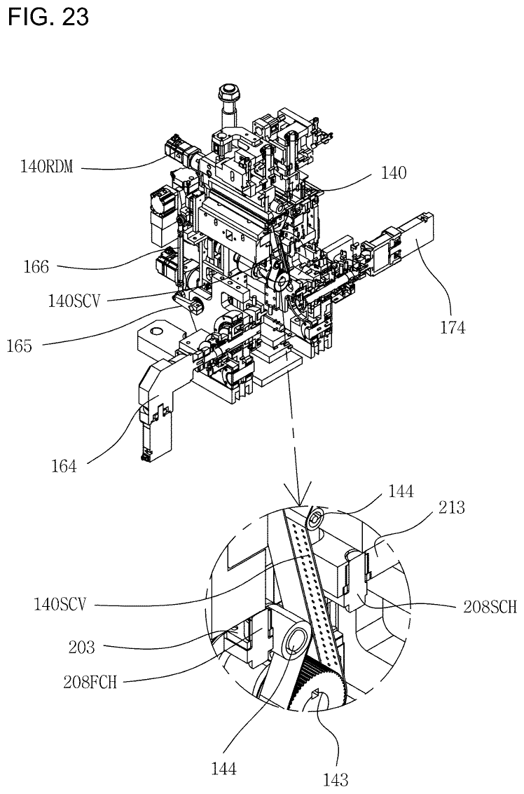

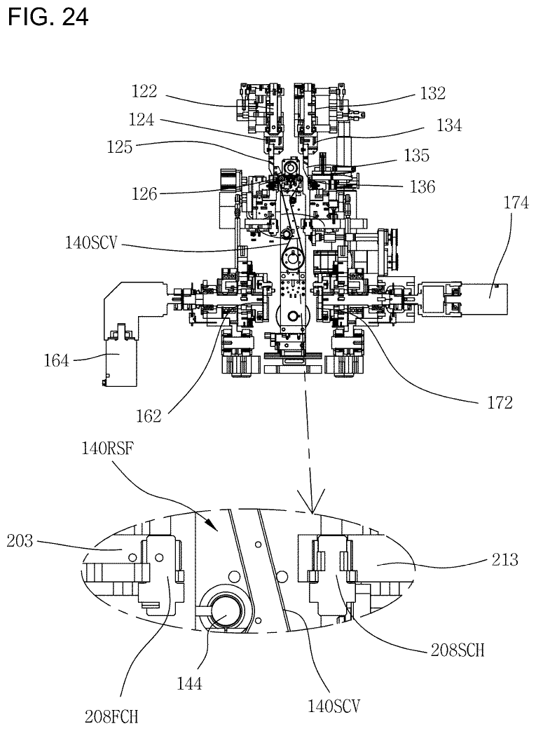

FIG. 23 is a half-cut perspective view showing an enlarged view of the main components, the first center hinge and the second center hinge part, of the present invention, and FIG. 24 is a right side view of FIG. 23.

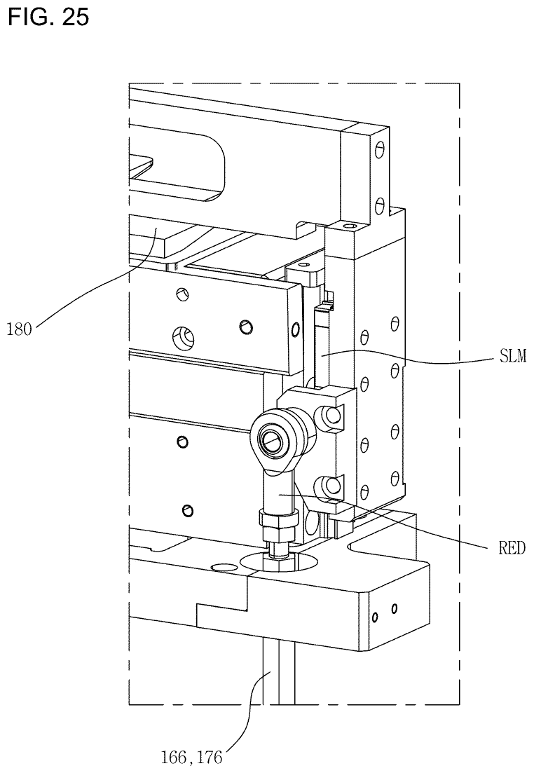

FIG. 25 is a view showing an enlarged view of the structure of the main components, the stripper, the stripper-side LM guide, the rod end bearing, the first lifting operation rod, and the second lifting operation rod part, of the present invention.

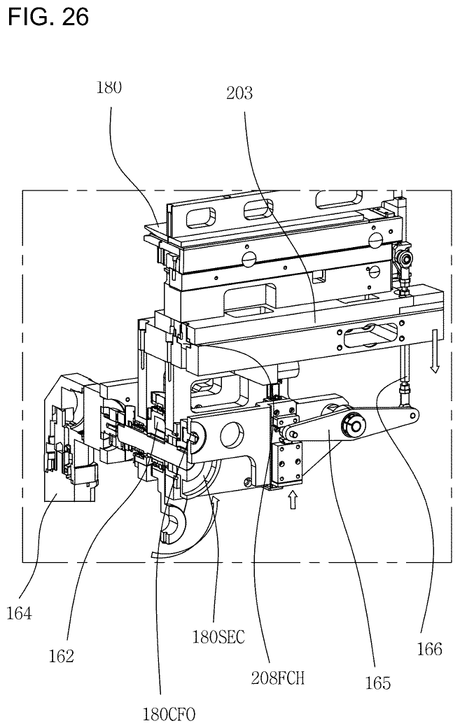

FIG. 26 is a half-cut perspective view schematically showing the structure of the main components, the stripper, the stripper drive cam, and the cam follower, of the present invention.

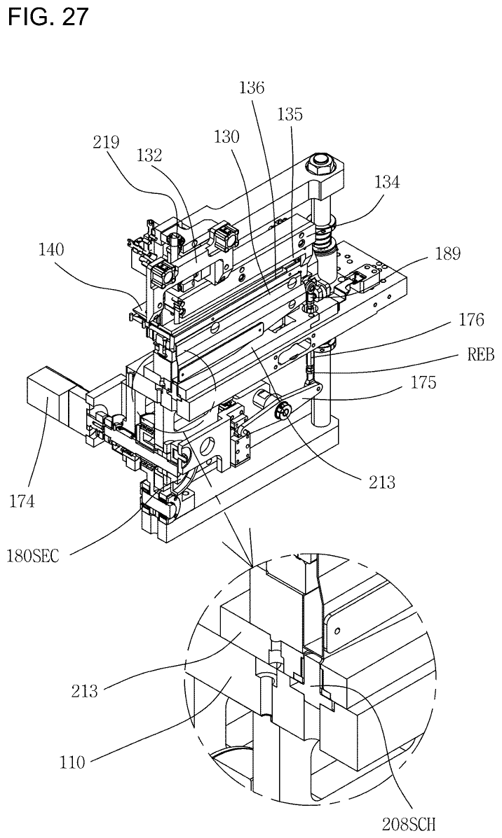

FIG. 27 is a half-cut perspective view showing an enlarged view of the main component, the second center hinge part, of the present invention.

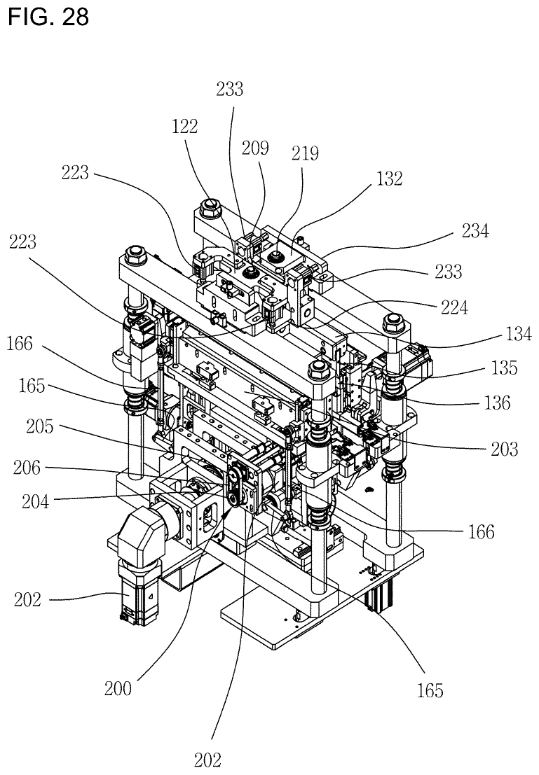

FIG. 28 is an enlarged view schematically showing the structure of the main components, the first correction drive motor, the second correction drive motor, the first correction ball screw, the second correction ball screw, the first correction ball screw nut, and the second correction ball screw nut part, for automatic adjustment of electrode plate feeding of the ultra-high-speed dual cutting system for secondary battery electrode plates with a feeding correction function according to the present invention.

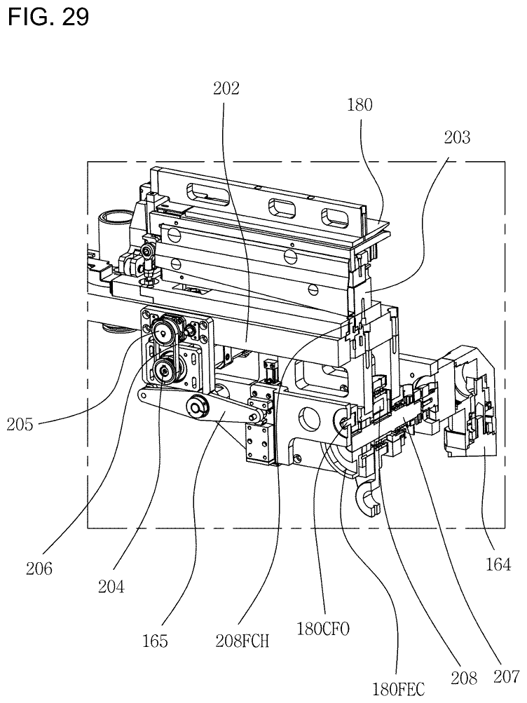

FIG. 29 is a half-cut front perspective view schematically showing the structure of the main components, the first correction ball screw nut, the first rotating body, and the first feeding correction unit, of the present invention.

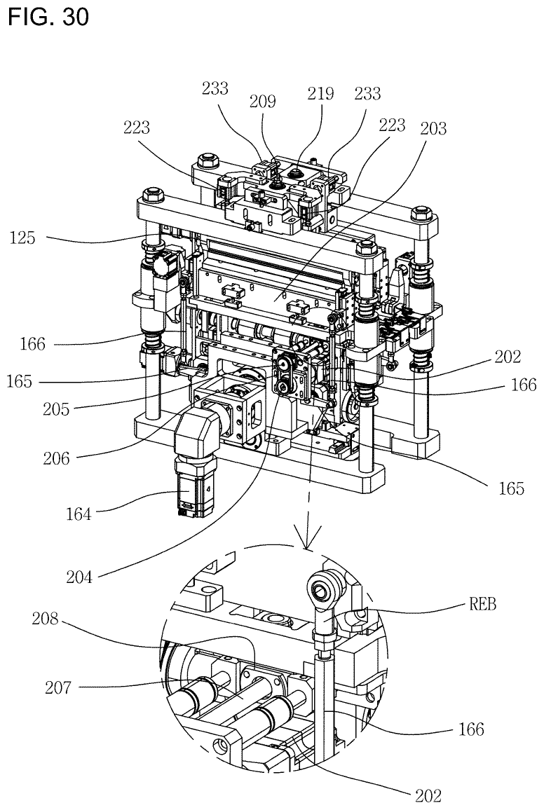

FIG. 30 is a perspective view showing an enlarged view of the main components, the first correction ball screw and the first correction ball screw nut part, of the first feeding correction unit, of the present invention.

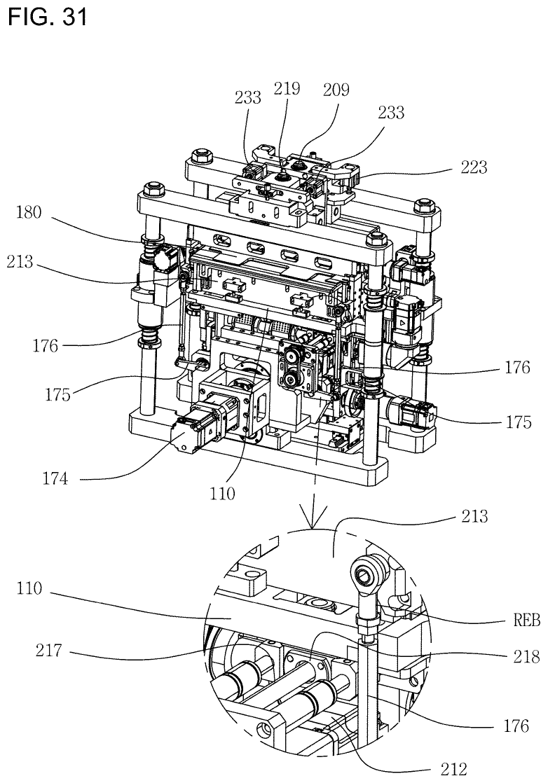

FIG. 31 is a perspective view showing an enlarged view of the main components, the second correction ball screw and the second correction ball screw nut part, of the second feeding correction unit, of the present invention.

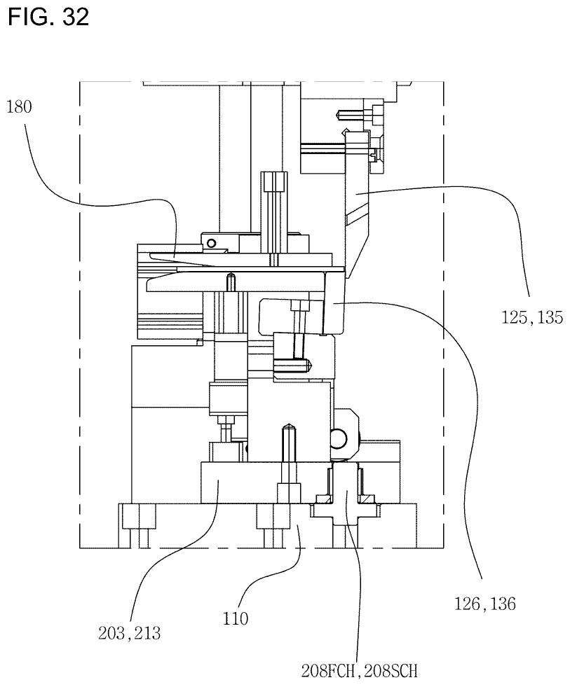

FIG. 32 is a side cross-sectional view schematically showing the structure of the main component, the center hinge part, of the electrode plate perpendicularity defect adjustment device, of the present invention.

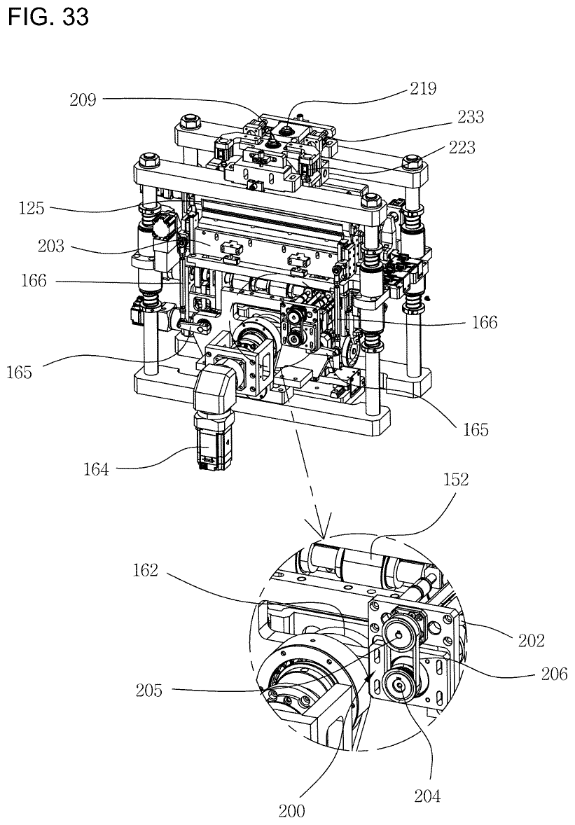

FIG. 33 is a right side perspective view showing an enlarged view of the main components, the first correction ball screw and the first correction ball screw nut part, of the first feeding correction unit, of the present invention.

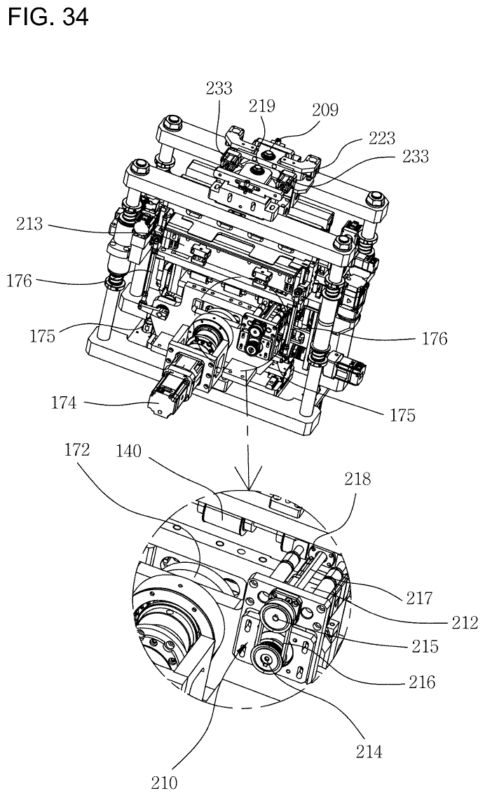

FIG. 34 is a left side perspective view showing an enlarged view of the main components, the second correction ball screw and the second correction ball screw nut part, of the second feeding correction unit, of the present invention.

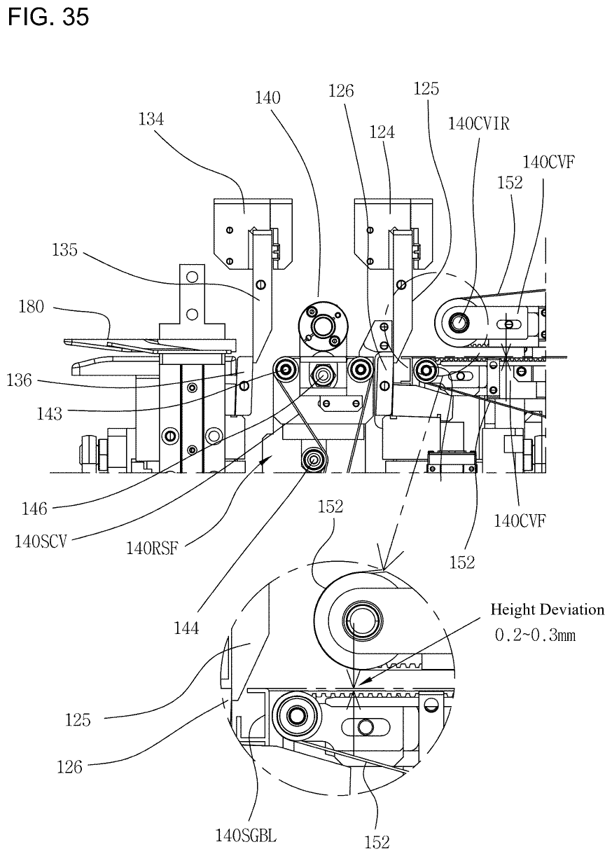

FIG. 35 is an enlarged view showing the main components, the suction guide block and the height deviation of the conveyor belt, of the ultra-high-speed dual cutting system for secondary battery electrode plates with a feeding correction function according to the present invention.

### DETAILED DESCRIPTION OF THE INVENTION

Hereinafter, a preferred embodiment of the present invention will be described in detail with reference to the accompanying drawings. The purpose, features, and advantages of the present invention can be more easily understood by referring to the accompanying drawings and the following detailed description. In addition, in describing the present invention, if it is determined that a detailed description of a related known configuration or function may obscure the gist of the present invention, the detailed description is omitted.

In addition, in describing the components of the present invention, terms such as first, second, A, B, (a), (b), and the like may be used. These terms are only for distinguishing the component from other components, and the essence, order, or sequence of the component is not limited by the terms. For example, when a component is described as being “connected,” “coupled,” or “attached” to another component, the component may be directly connected or attached to the other component, but it should be understood that another component may be “connected,” “coupled,” or “attached” between each component.

FIG. 1 is a left side perspective view of the ultra-high-speed dual cutting system for secondary battery electrode plates with a feeding correction function according to the present invention, FIG. 2 is an enlarged view of part A of FIG. 1 showing an enlarged structure of the main components, the first cutting adhesion cylinder and the second cutting adhesion cylinder part, FIG. 3 is a perspective view showing an enlarged view of the main components, the feeding roller and the suction pipe part, shown in FIG. 1, FIG. 4 is an enlarged view of part B of FIG. 3, FIG. 5 is a left side perspective view showing an enlarged view of the main component, the dual cutter part, of the ultra-high-speed dual cutting system for secondary battery electrode plates with a feeding correction function according to the present invention, FIG. 6 is an enlarged view of part C of FIG. 5, FIG. 7 is a right side view of the ultra-high-speed dual cutting system for secondary battery electrode plates with a feeding correction function according to the present invention, FIG. 8 is a perspective view showing an enlarged view of the structure of the main components, the feeding roller and the conveyor, of the ultra-high-speed dual cutting system for secondary battery electrode plates with a feeding correction function according to the present invention from the right side, FIG. 9 is a perspective view showing an enlarged view of the structure of the main components, the feeding roller and the conveyor, of the ultra-high-speed dual cutting system for secondary battery electrode plates with a feeding correction function according to the present invention from the left side, FIG. 10 is a view showing an enlarged view of the structure of the other main components, the feeding roller, the feeding roller drive motor, the auxiliary feeding belt drive motor, the feeding roller up-down drive motor, and the feeding roller up-down cam part, of the ultra-high-speed dual cutting system for secondary battery electrode plates with a feeding correction function according to the present invention.

Referring to the drawings, the ultra-high-speed dual cutting system for secondary battery electrode plates with a feeding correction function according to the present invention comprises a dual cutter for cutting a secondary battery electrode plate, and a feeding roller 140 and a conveyor capable of feeding the electrode plate between the cutters during cutting of the electrode plate by the dual cutter as a basic configuration.

The feeding roller 140 is configured to be disposed between the first upper cutter 125 and the second upper cutter 135 of the first cutting unit 120 and the second cutting unit 130 constituting the dual cutter. The feeding roller 140 is disposed above the electrode plate and configured to feed the electrode plate along a feeding line of the main support frame 110 together with the conveyor.

A feeding roller support frame 140RSF is coupled to the main support frame 110 to be capable of lifting, a feeding roller drive motor 140RDM is mounted to an upper end of the feeding roller support frame 140RSF, a center of a plurality of the feeding rollers 140 is coaxially coupled to a roller shaft coaxially coupled to a motor shaft of the feeding roller drive motor 140RDM, and the plurality of feeding rollers 140 are configured to feed the electrode plate along the feeding line of the main support frame 110 together with the conveyor.

Meanwhile, a suction pipe 146 (shown in FIG. 11 to FIG. 14) is disposed below the feeding roller 140. The suction pipe 146 will be described later.

In the present invention, the dual cutter comprises a first cutting unit 120 and a second cutting unit 130 supported by the main support frame 110.

Referring to FIG. 1 to FIG. 5, the first cutting unit 120 comprises a first cutting support bracket 122, a first cutting connection bracket 124, a first upper cutter 125, a first lower cutter 126, and a first cutting adhesion drive unit.

The first cutting support bracket 122 is mounted to the main support frame 110 via a first vertical rotation shaft 209. The first cutting support bracket 122 is configured to be capable of rotating in a horizontal direction on the main support frame 110 based on the first vertical rotation shaft 209.

The first upper cutter 125 is coupled to the first cutting connection bracket 124 mounted to the first cutting support bracket 122 via a first horizontal hinge 123. The first upper cutter 125 is mounted to a lower part of the first cutting connection bracket 124. The first upper cutter 125 is disposed in a vertical direction.

The first lower cutter 126 is supported by the main support frame 110. A first rotating body 203 is mounted on a main support top plate of the main support frame 110 via a first center hinge 208FCH (shown in FIG. 23, FIG. 24, and FIG. 28), and the first lower cutter 126 is mounted to the first rotating body 203. Referring to FIG. 6 to FIG. 10, the first lower cutter 126 is disposed on the rotating body.

An inner surface of the first lower cutter 126 is configured to closely contact an inner surface of the first upper cutter 125.

The present invention comprises a first cutting adhesion drive unit that closely contacts the first upper cutter 125 to the first lower cutter 126.

Referring to FIG. 1 to FIG. 4 and FIG. 17, the first cutting adhesion drive unit comprises a first cutting adhesion cylinder 223 and a first cutter adhesion operation bracket 224.

The first cutting adhesion cylinder 223 is mounted to the first cutting support bracket 122. A cylinder rod of the first cutting adhesion cylinder 223 is disposed in a vertical direction.

The first cutter adhesion operation bracket 224 is provided on the first cutting connection bracket 124 connected to the first cutting support bracket 122 via the first horizontal hinge 123. The first cutter adhesion operation bracket 224 is disposed at a position capable of being pressed by the cylinder rod of the first cutting adhesion cylinder 223. An adhesion operation bracket on the first cutter is disposed in a horizontal direction.

The second cutting unit 130 comprises a second cutting support bracket 132, a second cutting connection bracket 134, a second upper cutter 135, a second lower cutter 136, and a second cutting adhesion drive unit.

The second cutting support bracket 132 is mounted to the main support frame 110 via a second vertical rotation shaft 219. The second cutting support bracket 132 is mounted to the main support frame 110 based on the second vertical rotation shaft 219 and disposed at a position facing the first cutting support bracket. The second cutting support bracket 132 is configured to be capable of rotating in a horizontal direction on the main support frame 110 based on the second vertical rotation shaft 219.

The second upper cutter 135 is coupled to the second cutting connection bracket 134 mounted to the second cutting support bracket 132 via a second horizontal hinge 133. The second upper cutter 135 is mounted to a lower part of the second cutting connection bracket 134. The second upper cutter 135 is disposed in a vertical direction.

The second lower cutter 136 is supported by the main support frame 110. A second rotating body 213 is mounted on a main support top plate of the main support frame 110 via a second center hinge 208SCH (shown in FIG. 23, FIG. 24, and FIG. 28), and the second lower cutter 136 is mounted to the second rotating body 213. Referring to FIG. 6 to FIG. 10, the second lower cutter 136 is disposed on the rotating body.

An inner surface of the second lower cutter 136 is configured to closely contact an inner surface of the second upper cutter 135.

The present invention comprises a second cutting adhesion drive unit that closely contacts the second upper cutter 135 to the second lower cutter 136.

Referring to FIG. 1 to FIG. 4 and FIG. 17, the second cutting adhesion drive unit comprises a second cutting adhesion cylinder 233 and a second cutter adhesion operation bracket 234.

The second cutting adhesion cylinder 233 is mounted to the second cutting support bracket 132. A cylinder rod of the second cutting adhesion cylinder 233 is disposed in a horizontal direction.

The second cutter adhesion operation bracket 234 is provided on the second cutting connection bracket 134 connected to the second cutting support bracket 132 via the second horizontal hinge 133. The second cutter adhesion operation bracket 234 is disposed at a position capable of being pressed by the cylinder rod of the second cutting adhesion cylinder 233. An adhesion operation bracket on the second cutter is disposed in a vertical direction.

The present invention further comprises a first cutting operation unit and a second cutting operation unit provided on the main support frame 110.

Referring to FIG. 33, the first cutting operation unit comprises a first upper cutter lifting cam 162 rotatably provided on the main support frame 110, a first cam drive motor 164 with a motor shaft connected to the first upper cutter lifting cam 162, a pair of left and right first levers 165 with base ends relatively rotatably coupled to the first upper cutter lifting cam 162, a pair of left and right first lifting operation rods 166 with lower ends connected to front ends of the pair of first levers 165 via a rod end bearing REB, and a first upper cutting support bracket 167 connected to upper ends of the pair of first lifting operation rods 166 via a rod end bearing REB and connected to the first cutting support bracket 122 supporting the first upper cutter 125. The first upper cutting support bracket 167 may be configured to be connected to the first cutting support bracket 122 by a connecting means such as a connecting bracket and a bolt.

Referring to FIG. 34, the second cutting operation unit comprises a second upper cutter lifting cam 172 rotatably provided on the main support frame 110, a second cam drive motor 174 with a motor shaft connected to the second upper cutter lifting cam 172, a pair of left and right second levers 175 with base ends relatively rotatably coupled to the second upper cutter lifting cam 172, a pair of left and right second lifting operation rods 176 with lower ends connected to front ends of the pair of second levers 175 via a rod end bearing REB, and a second upper cutting support bracket 177 connected to upper ends of the pair of second lifting operation rods 176 via a rod end bearing REB and connected to the second cutting support bracket 132 supporting the second upper cutter 135. The second upper cutting support bracket 177 may be configured to be connected to the second cutting support bracket 132 by a connecting means such as a connecting bracket and a bolt.

In addition, a stripper 180 is mounted to the main support frame 110 to be capable of lifting, and is configured such that the stripper 180 lifts during lifting of the first upper cutting support bracket 167 and the first upper cutter 125 and lifting of the second upper cutting support bracket 177 and the second upper cutter 135.

Referring to FIG. 26, the present invention comprises a stripper lifting cam 180SEC rotatably coupled to the main support frame 110, and a cam follower 180CFO with a base end connected to the stripper lifting cam 180SEC.

The stripper lifting cam 180SEC is coupled to a motor shaft of the first cam drive motor 164, and when the stripper lifting cam 180SEC rotates according to driving of the first cam drive motor 164, the cam follower ascends and descends, causing the stripper lifting member to ascend and descend, and the stripper 180 ascends and descends according to lifting of the stripper 180 lifting rod.

In addition, the ultra-high-speed dual cutting system for secondary battery electrode plates further comprises a feeding correction unit supported by the main support frame 110. Here, the feeding correction unit comprises a first feeding correction unit 200 and a second feeding correction unit 210. In the present invention, the feeding correction unit can be referred to as an electrode plate perpendicularity defect correction unit that adjusts perpendicularity defects of the electrode plate.

Referring to FIG. 20, the first feeding correction unit 200 may comprise a first correction drive motor 202 mounted to the main support frame 110, a first rotating body 203 (lower cutter unit) coupled to the main support frame 110 via a first center hinge 208FCH, a first correction drive pulley 204 coaxially coupled to a motor shaft of the first correction drive motor 202, a first correction driven pulley 205 rotatably mounted to the first rotating body 203 (lower cutter unit), a first correction belt 206 coupled to the first correction drive pulley 204 and the first correction driven pulley 205, a first correction ball screw 207 coaxially coupled to a center of the first correction driven pulley 205, a first correction ball screw nut 208 coupled to an outer peripheral surface of the first correction ball screw 207 and with an upper end coupled to the first rotating body 203 via a hinge, and a first vertical rotation shaft 209 that rotatably couples the first upper cutting support bracket 167 connected to the first cutting support bracket 122 supporting the first upper cutter 125 to the main support frame 110 in a horizontal direction.

The first rotating body 203 is shown in FIG. 6 to FIG. 8, and the first vertical rotation shaft 209 is shown in FIG. 1 and FIG. 4.

In addition, referring to FIG. 21, the second feeding correction unit 210 comprises a second correction drive motor 212 mounted to the main support frame 110, a second rotating body 213 (lower cutter unit) coupled to the main support frame 110, a second correction drive pulley 214 coaxially coupled to a motor shaft of the second correction drive motor 212, a second correction driven pulley 215 rotatably mounted to the second rotating body 213, a second correction belt 216 coupled to the second correction drive pulley 214 and the second correction driven pulley 215, a second correction ball screw 217 coaxially coupled to a center of the second correction driven pulley 215, a second correction ball screw nut 218 coupled to an outer peripheral surface of the second correction ball screw 217 and with an upper end coupled to the second rotating body 213 via a hinge, and a second vertical rotation shaft 219 that rotatably couples the second upper cutting support bracket 177 connected to the second cutting support bracket 132 supporting the second upper cutter 135 to the main support frame 110 in a horizontal direction.

The second rotating body 213 is shown in FIG. 6 to FIG. 8, and the second vertical rotation shaft 219 is shown in FIG. 1 and FIG. 4.

In addition, referring to FIG. 1, FIG. 3, FIG. 5, and FIG. 8 to FIG. 14, in the present invention, the conveyor is configured to comprise a conveyor belt 152 that travels in an endless track on an electrode plate feeding line of the main support frame 110, wherein two conveyor belts 152, upper and lower, travel in the endless track at an upper part and a lower part of the electrode plate to feed the electrode plate, and the feeding roller 140 is disposed at the upper part of the electrode plate and configured to feed the electrode plate together with the conveyor belt 152.

Here, the conveyor belt 152 comprises a suction belt having a plurality of suction holes penetrating upper and lower surfaces, and is configured such that the conveyor belt 152 travels in an endless track in a conveyor frame, and the conveyor frame is configured to have a plurality of frame-side suction holes communicating with the suction holes.

Referring to FIG. 15 and FIG. 16, the conveyor belt 152 travels in an endless track via upper and lower surfaces of an upper and lower conveyor frame 140CVF supported by the main support frame 110, passing through a conveyor-side idle roller 140CVIR and a conveyor-side drive roller 140CVDR at front and rear ends of the upper and lower conveyor frame 140CVF, and a plurality of the conveyor belts 152 are arranged side by side in a left-right width direction of the main support frame 110.

Inside a plurality of the conveyor belts 152, a conveyor-side idle roller 140CVIR and a conveyor-side drive roller 140CVDR provided at front and rear ends of the conveyor frame 140CVF are disposed, the conveyor belt 152 is coupled to pass through outer peripheral surfaces of the conveyor-side idle roller 140CVIR and the conveyor-side drive roller 140CVDR, and the conveyor belt 152 is configured to pass through upper and lower surfaces of the conveyor frame 140CVF, so that the conveyor belt 152 travels in an endless track via the upper and lower surfaces of the conveyor frame 140CVF. Of course, a feeding belt drive motor 140MVDM, with a motor shaft coaxially coupled to a center of the conveyor-side drive roller 140CVDR, is mounted to the conveyor frame 140CVF, so that the conveyor belt 152 can travel in an endless track passing through the upper and lower surfaces and front and rear ends of the conveyor frame 140CVF according to driving of the feeding belt drive motor 140MVDM.

The conveyor belt 152 is configured to feed the electrode plate on a feeding line of the main support frame 110 between the conveyor and the feeding roller 140 (that is, between the conveyor belt 152 and the feeding roller 140) by an endless track travel of the conveyor belt 152 in a state where a bottom surface of the electrode plate is suctioned by a suction pressure acting on the suction holes of the conveyor belt 152 and frame-side suction holes of the conveyor frame 140CVF.

In the present invention, the conveyor comprises an upper conveyor and a lower conveyor respectively disposed on an upper surface and a bottom surface of the electrode plate fed along a feeding line of the main support frame 110, and can be configured to feed the electrode plate along the feeding line of the main support frame 110 by an endless track travel of an upper conveyor belt 152 and a lower conveyor belt 152.

Referring to FIG. 11 to FIG. 15, a plurality of the feeding rollers 140 are rotatably mounted to the main support frame 110, and a plurality of the feeding rollers 140 are arranged side by side in a left-right width direction of the main support frame 110. In addition, a suction pipe 146 is disposed below the plurality of the feeding

rollers 140. The suction pipe 146 is coupled to the feeding roller support frame 140RSF coupled to the main support frame 110 to be capable of lifting, so that the suction pipe 146 is disposed below the plurality of feeding rollers 140. The suction pipe 146 may be provided with a plurality of pipe-side suction holes penetrating inner and outer peripheral surfaces.

In addition, referring to FIG. 11 to FIG. 14, a feeding roller up-down drive motor 140UDM is mounted to the main support frame 110, a feeding roller up-down cam 140UDC is coupled to a motor shaft of the feeding roller up-down drive motor 140UDM, the feeding roller support frame 140RSF capable of lifting is coupled to the feeding roller up-down cam 140UDC and the main support frame 110, a plurality of guide rollers 143 are rotatably coupled to the feeding roller support frame 140RSF, an auxiliary feeding conveyor belt 140SCV traveling in an endless track is coupled to outer peripheral surfaces of the plurality of guide rollers 143, the auxiliary feeding conveyor belt 140SCV is coupled via an outer peripheral surface of an auxiliary feeding drive roller 140SCDR connected to a motor shaft of an auxiliary feeding belt drive motor 140SVM and outer peripheral surfaces of the plurality of guide rollers 143 in a vertically standing state, and is configured to travel in the endless track via the outer peripheral surfaces of the auxiliary feeding conveyor belt 140SCV and the plurality of guide rollers 143 according to driving of the auxiliary feeding belt drive motor 140SVM, a plurality of the feeding rollers 140 are coupled to the feeding roller support frame 140RSF via a roller shaft coupled at a center, and the plurality of feeding rollers 140 are configured to be disposed above the feeding conveyor belt 152. The plurality of feeding rollers 140 are configured to be disposed above the suction pipe 146 and simultaneously above the feeding conveyor belt 152.

In addition, the feeding roller support frame 140RSF is provided with a plurality of tension rollers 144, and is configured to enable tension adjustment of the feeding conveyor belt 152 by the plurality of tension rollers 144.

Here, the plurality of the guide rollers 143 are rotatably mounted to the main support frame 110. The plurality of guide rollers 143 are coaxially coupled to a roller shaft rotatably coupled to an upper end of the feeding roller support frame 140RSF via a bracket and a bearing, so that the plurality of guide rollers 143 are rotatably mounted to the main support frame 110.

Meanwhile, according to the present invention, there is provided an ultra-high-speed dual cutting method for secondary battery electrode plates using an ultra-high-speed dual cutting system for secondary battery electrode plates with a feeding correction function, comprising a dual cutter for cutting a secondary battery electrode plate, and the feeding roller 140 and a conveyor capable of feeding the electrode plate between the cutters during cutting of the electrode plate by the dual cutter, the method comprising an electrode plate feeding step of feeding the electrode plate to be cut along a feeding line by the feeding roller 140 and the conveyor, and an electrode plate dual cutting step of cutting the electrode plate fed along the feeding line using the dual cutter.

According to the configuration of the present invention, when a motor shaft of the first cam drive motor 164 of the first cutting unit 120 rotates in one direction (for example, clockwise), the first upper cutter lifting cam 162 rotates in one direction (for example, clockwise), front ends of a pair of the first levers 165 rotate upward, and the first upper cutting support bracket 167 and the first upper cutter 125 ascend, and when the motor shaft of the first cam drive motor 164 rotates in the other direction (for example, counterclockwise), the first upper cutter lifting cam 162 rotates in the other direction (for example, counterclockwise), the front ends of the pair of the first levers 165 descend downward, and the first upper cutting support bracket 167 and the first upper cutter 125 descend.

Meanwhile, when a motor shaft of the second cam drive motor 174 of the second cutting operation unit rotates in one direction (for example, clockwise), the second upper cutter lifting cam 172 rotates in one direction (for example, clockwise), front ends of a pair of the second levers 175 rotate upward, and the second upper cutting support bracket 177 and the second upper cutter 135 ascend, and when the motor shaft of the second cam drive motor 174 rotates in the other direction (for example, counterclockwise), the second upper cutter lifting cam 172 rotates in the other direction (for example, counterclockwise), the front ends of the pair of the second levers 175 descend downward, and the second upper cutting support bracket 177 and the second upper cutter 135 descend.

The first cutting unit 120 and the second cutting unit 130 of the above configuration are configured to operate simultaneously.

The first upper cutter 125 and the second upper cutter 135 of the first cutting unit 120 and the second cutting unit 130 ascend simultaneously, and in a state where the electrode plate is fed between the first upper cutter 125 and the first lower cutter 126 and the second upper cutter 135 and the second lower cutter 136 of the first cutting unit 120 and the second cutting unit 130 by a suction pressure acting from a plurality of suction holes of the conveyor belt 152 traveling in an endless track of the conveyor and a plurality of frame-side suction holes of the conveyor frame and by a plurality of the feeding rollers 140, the first upper cutter 125 and the second upper cutter 135 of the first cutting unit 120 and the second cutting unit 130 descend again simultaneously to perform dual cutting by simultaneously cutting both sides of the electrode plate by the first upper cutter 125 and the first lower cutter 126 and the second upper cutter 135 and the second lower cutter 136.

Therefore, the present invention enables ultra-high-speed dual cutting because both sides of the electrode plate are simultaneously cut by the first cutting unit 120 and the second cutting unit 130, performing dual cutting.

In addition, the ultra-high-speed dual cutting system for secondary battery electrode plates further comprises a first cutting adhesion drive unit and a second cutting adhesion drive unit that closely contact the first upper cutter 125 and the second upper cutter 135 to the first lower cutter 126 and the second lower cutter 136, respectively.

Here, the first cutting adhesion drive unit comprises a first cutting adhesion cylinder 223 mounted to the first cutting support bracket 122 with a cylinder rod disposed in a vertical direction, and a first cutter adhesion operation bracket 224 provided on the first cutting connection bracket 124 connected to the first cutting support bracket 122 via the first horizontal hinge 123 and disposed at a position capable of being pressed by the cylinder rod of the first cutting adhesion cylinder 223.

The first cutting adhesion cylinder 233 is mounted to the main support frame 110. A cylinder rod of the first cutting adhesion cylinder 233 presses the first cutting support bracket 122 downward to rotate the first cutting support bracket 122 toward the first lower cutter 126 based on the first horizontal hinge 123 connected to the main support frame 110, so that the first upper cutter 125 closely contacts the first lower cutter 126. An inner surface of the first upper cutter 125 closely contacts an inner surface of the first lower cutter 126. Please refer to FIG. 31.

In addition, the second cutting adhesion drive unit comprises a second cutting adhesion cylinder 233 mounted to the second cutting support bracket 132 with a cylinder rod disposed in a horizontal direction, and a second cutter adhesion operation bracket 234 provided on the main support frame and disposed at a position capable of being pressed by the cylinder rod of the second cutting adhesion cylinder 233.

The second cutting adhesion cylinder 233 is mounted to the main support frame 110. A cylinder rod of the second cutting adhesion cylinder 233 pushes the second cutting support bracket 132 in a horizontal direction to rotate the second cutting support bracket 132 to be pushed based on the second horizontal hinge 133 connected to the main support frame 110, so that the second upper cutter 135 closely contacts the second lower cutter 136. An inner surface of the second upper cutter 135 closely contacts an inner surface of the second lower cutter 136. Pleases refer to FIG. 31.

Therefore, the present invention ensures that when both sides of the electrode plate are cut by the first upper cutter 125 and the first lower cutter 126 and the second upper cutter 135 and the second lower cutter 136, the first upper cutter 125 and the first lower cutter 126 are always closely contacted, and the second upper cutter 135 and the second lower cutter 136 are also always closely contacted, thereby reliably preventing cases where cutting defects of the electrode plate occur during dual cutting of both sides of the electrode plate.

In addition, according to the present invention, when a feeding misalignment occurs during feeding of the electrode plate along a feeding line of the main support frame 110, a first feeding correction drive pulley and a first feeding correction driven pulley rotate forward and backward by driving of the first correction drive motor 202, and the first correction ball screw 207 rotates, and simultaneously, a second feeding correction drive pulley and a second feeding correction driven pulley rotate forward and backward by driving of the second correction drive motor 212, and a second correction ball screw rotates, and the first correction ball screw nut 208 and the second correction ball screw nut 218 simultaneously move forward and backward, wherein the first correction ball screw nut 208 and the second correction ball screw nut 218 are disposed at positions symmetrical in a diagonal direction with respect to an imaginary centerline in a longitudinal direction between left and right side ends of the main support frame 110, so that the first cutting support bracket 122, the first cutting connection bracket 124, the first upper cutting support bracket 167, the second cutting support bracket 132, the second cutting connection bracket 134, and the second upper cutting support bracket 177 are simultaneously horizontally rotated in a direction intersecting the electrode plate feeding line based on the first center hinge 208FCH and the second center hinge 208SCH, and in this state, the first upper cutter 125 and the second upper cutter 135 are simultaneously lowered toward the first lower cutter 126 and the second lower cutter 136 to cut both sides of the electrode plate in a state where the feeding position misalignment is corrected.

Therefore, the present invention has an effect of preventing cutting defects of the electrode plate because the feeding position misalignment of the electrode plate is immediately corrected to cut the electrode plate even if a feeding position misalignment phenomenon is about to occur during feeding of the electrode plate. In other words, the present invention can expect an effect of preventing cutting defects of the electrode plate by adjusting perpendicularity defects of the electrode plate. In other words, the present invention applies a servo, that is, applies the first correction drive motor 202 and the second correction drive motor 212 as servo motors to automatically adjust a cutting position of the electrode plate during feeding of the electrode plate, thereby performing a function of adjusting perpendicularity defects of the electrode plate.

In the present invention, the feeding correction refers to aligning a cutting position of the electrode plate by the first upper cutter 125 and the first lower cutter 126 and the second upper cutter 135 and the second lower cutter 136, so that both side ends of the electrode plate are properly cut in a direction perpendicular to front and rear ends of the electrode plate.

In addition, the present invention can expect an effect of more reliably preventing a feeding position misalignment phenomenon of the electrode plate because the electrode plate is fed and cut along a feeding line of the main support frame 110 by the conveyor belt 152 comprising a suction belt and the feeding roller 140.

In addition, in the present invention, the suction pipe 146 disposed below the feeding roller 140 has a plurality of pipe-side suction holes formed on an outer peripheral surface outside a plurality of the feeding rollers 140, so that the electrode plate is fed in a state of being suctioned with an appropriate force by a suction pressure acting from the plurality of pipe-side suction holes, thereby having an effect of more reliably preventing a feeding position misalignment phenomenon of the electrode plate.

In addition, referring to FIG. 22, FIG. 26, and FIG. 27, the present invention has an effect of stable stripping and prevention of noise and vibration with a small stroke because the stripper 180 is applied separately from a cutter drive unit.

In addition, referring to FIG. 26 and FIG. 27, the present invention mounts two types of cams, a cutter drive cam and a stripper drive cam, on a single drive shaft (servo), so that the cutter and the stripper are driven with different strokes, and has a stripper descending structure connected to a lever by a rod end bearing while the cam rotates and the lever operates. For example, a stripper stroke of 4 mm is applied in the present invention.

In other words, the stripper 180 is mounted to the main support frame 110 to be capable of lifting, and is configured such that the stripper 180 ascends and descends during lifting of the first upper cutting support bracket 167 and the first upper cutter 125.

In this way, the stripper 180 is applied separately from the cutter drive unit, providing an effect of stable stripping and prevention of noise and vibration with a small stroke.

In addition, in the present invention, a plurality of the feeding rollers 140 and the feeding conveyor belt 152 are disposed on an electrode plate feeding line of the main support frame 110, and the electrode plate is guided to be fed by the plurality of feeding rollers 140 and the feeding conveyor, so that a cutting operation of both sides of the electrode plate by the dual cutter, that is, the first cutting unit 120 and the second cutting unit 130, is performed more smoothly.

In addition, the feeding roller up-down cam 140UDC rotates by driving of the feeding roller up-down drive motor 140UDM provided on the main support frame 110, and the feeding roller support frame 140RSF ascends and descends, so that a gap between the feeding roller 140 and the feeding conveyor belt 152 is adjusted, thereby enabling smooth feeding of the electrode plate corresponding to a thickness of the electrode plate.

In addition, a plurality of the tension rollers 144 provided on the feeding roller support frame 140RSF adjust a tension (tensile force) of the feeding conveyor belt 152 by moving forward or backward toward the feeding conveyor belt 152 by a forward-backward operation means (for example, a forward-backward operation cylinder, etc., not shown), thereby enabling smoother feeding of the electrode plate corresponding to the thickness of the electrode plate.

In addition, as shown in FIG. 35, in the present invention, a suction guide block 140SGBL is further provided on an electrode plate feeding line of the main support frame 110, and the suction guide block 140SGBL is provided with a suction chamber and a suction guide-side suction hole connected to a suction device (not shown), so that the electrode plate is suctioned with an appropriate suction pressure by the suction guide block 140SGBL and guided to be fed along the electrode plate feeding line of the main support frame 110, thereby increasing a feeding precision of the electrode plate.

In addition, a height deviation (for example, a height deviation of 0.2 to 0.3 mm) relatively higher than a height of the suction guide block 140SGBL is secured compared to a height of the conveyor belt 152, which is a main component of the conveyor, so that the electrode plate fed along the feeding line of the main support frame 110 is fed more smoothly without being caught.

In addition, in the present invention, a cylinder rod of the first cutting adhesion cylinder 233 presses the first cutting support bracket 122 downward to rotate the first cutting support bracket 122 toward the first lower cutter 126 based on the first horizontal hinge 123 connected to the main support frame 110, so that the first upper cutter 125 closely contacts the first lower cutter 126, and simultaneously, a cylinder rod of the second cutting adhesion cylinder 233 pushes the second cutting support bracket 132 in a horizontal direction to rotate the second cutting support bracket 132 to be pushed based on the second horizontal hinge 133 connected to the main support frame 110, so that the second upper cutter 135 closely contacts the second lower cutter 136, and in this state, dual cutting is performed to simultaneously cut both sides of the electrode plate, thereby enabling more accurate performance of the dual cutting operation of both sides of the electrode plate. In other words, in the present invention, a position of a center hinge, which is a rotation shaft, is made identical to a cutting position of the electrode plate (a position where the first upper cutter 125 and the first lower cutter 126 and the second upper cutter 135 and the second lower cutter 136 contact) to be designed to be adjusted more accurately.

In addition, referring to FIG. 19, in the present invention, the stripper 180, a stripper-side LM guide SLM, and a rod end bearing REB are applied, and a stripper operation is performed by an LM guide applied to a cutter side, so that the stripper operation of the stripper 180 is performed precisely and smoothly.

In addition, referring to FIG. 25, in the present invention, a cam-side LM guide CLM, a cam push device CMP, a spring SP, a lever (that is, a pair of the first levers 165 and a pair of the second levers 175), and a rod end bearing REB (that is, a rod end bearing REB provided at upper ends and lower ends of a pair of the first lifting operation rods 166 and the second lifting operation rods 176) are applied, and a lever operation is performed by the cam-side LM guide CLM and the cam push device, so that a stroke and a position can be adjusted by adjusting the spring and the rod end bearing, thereby enabling easy adjustment of a dual cutting precision of both sides of the electrode plate by the first cutting unit 120 and the second cutting unit 130.

Terms such as “comprise,” “constitute,” or “have” described above mean that the corresponding component may be included unless specifically stated otherwise, and should be interpreted as being able to further include other components rather than excluding other components. All terms, including technical or scientific terms, have the same meaning as generally understood by a person of ordinary skill in the art to which the present invention pertains, unless otherwise defined. Terms commonly used, such as those defined in a dictionary, should be interpreted as consistent with the contextual meaning of the related art, and should not be interpreted in an ideal or excessively formal sense unless explicitly defined in the present invention.

The above description is merely illustrative of the technical idea of the present invention, and a person of ordinary skill in the art to which the present invention pertains may make various modifications and variations within a scope not departing from the essential characteristics of the present invention. Therefore, the embodiments disclosed in the present invention are not intended to limit the technical idea of the present invention but to explain it, and the scope of the technical idea of the present invention is not limited by these embodiments. A protection scope of the present invention should be interpreted by the following claims, and all technical ideas within a scope equivalent thereto should be interpreted as being included in the scope of rights of the present invention.

DESCRIPTION OF REFERENCE NUMERALS

| | |
|---|---|
| 110. Main support frame. | |
| 120. First cutting unit. | |
| 122. First cutting support bracket. | 123. First horizontal hinge. |
| 124. First cutting connection bracket. | 125. First upper cutter. |
| 126. First lower cutter. | |
| 130. Second cutting unit. | |
| 132. Second cutting support bracket. | 133. Second horizontal hinge. |
| 134. Second cutting connection bracket. | 135. Second upper cutter. |
| 136. Second lower cutter. | |
| 140. Feeding roller. | |
| 143. Guide roller. | |
| 144. Tension roller. | |
| 146. Suction pipe. | |
| 152. Conveyor belt. | |

What is claimed is:

1. An ultra-high-speed dual cutting system for secondary battery electrode plates with a feeding correction function, comprising:
a dual cutter provided on a main support frame 110 to cut a secondary battery electrode plate, and
a feeding roller 140 and a conveyor capable of feeding the electrode plate along a feeding line of the main support frame 110 between the cutters during cutting of the electrode plate by the dual cutter.

2. The ultra-high-speed dual cutting system for secondary battery electrode plates according to claim 1,
wherein the dual cutter comprises a first cutting unit 120 and a second cutting unit 130 supported by the main support frame 110,
wherein the first cutting unit 120 comprises a first cutting support bracket 122 mounted to the main support frame 110 via a first vertical rotation shaft 209, a first cutting connection bracket 124 mounted to the first cutting support bracket 122 via a first horizontal hinge 123, a first upper cutter 125 mounted to the first cutting connection bracket 124, a first lower cutter 126 supported by the main support frame 110 with an inner surface closely contacting an inner surface of the first upper cutter 125, and a first cutting adhesion cylinder 233 mounted to the main support frame 110 with a cylinder rod pressing the first cutting support bracket 122 downward to rotate the first cutting support bracket 122 toward the first lower cutter 126 based on the first horizontal hinge 123 connected to the main support frame 110, and
wherein the second cutting unit 130 comprises a second cutting support bracket 132 mounted to the main support frame 110 via a second vertical rotation shaft 219 and disposed at a position facing the first cutting support bracket, a second cutting connection bracket 134 mounted to the second cutting support bracket 132 via a second horizontal hinge 133, a second upper cutter 135 mounted to the second cutting connection bracket 134, a second lower cutter 136 supported by the main support frame 110 with an inner surface closely contacting an inner surface of the second upper cutter 135, and a first cutting adhesion cylinder 233 mounted to the main support frame 110 with a cylinder rod pressing the second cutting support bracket 132 downward to rotate the second cutting support bracket 132 toward the second lower cutter 136 based on the second horizontal hinge 133 connected to the main support frame 110.

3. The ultra-high-speed dual cutting system for secondary battery electrode plates according to claim 2, further comprising a first cutting operation unit and a second cutting operation unit provided on the main support frame 110,
wherein the first cutting operation unit comprises a first upper cutter lifting cam 162 rotatably provided on the main support frame 110, a first cam drive motor 164 with a motor shaft connected to the first upper cutter lifting cam 162, a pair of left and right first levers 165 with base ends relatively rotatably coupled to the first upper cutter lifting cam 162, a pair of left and right first lifting operation rods 166 with lower ends connected to front ends of the pair of first levers 165 via a rod end bearing REB, and a first upper cutting support bracket 167 connected to upper ends of the pair of first lifting operation rods 166 via a rod end bearing REB and connected to the first cutting support bracket 122 supporting the first upper cutter 125, and the second cutting operation unit comprises a second upper cutter lifting cam 172 rotatably provided on the main support frame 110, a second cam drive motor 174 with a motor shaft connected to the second upper cutter lifting cam 172, a pair of left and right second levers 175 with base ends relatively rotatably coupled to the second upper cutter lifting cam 172, a pair of left and right second lifting operation rods 176 with lower ends connected to front ends of the pair of second levers 175 via a rod end bearing REB, and a second upper cutting support bracket 177 connected to upper ends of the pair of second lifting operation rods 176 via a rod end bearing REB and connected to the second cutting support bracket 132 supporting the second upper cutter 135.

4. The ultra-high-speed dual cutting system for secondary battery electrode plates according to claim 3,
wherein a stripper 180 is mounted to the main support frame 110 to be capable of lifting, and is configured such that the stripper 180 lifts during lifting of the first upper cutting support bracket 167 and the first upper cutter 125 and lifting of the second upper cutting support bracket 177 and the second upper cutter 135.

5. The ultra-high-speed dual cutting system for secondary battery electrode plates according to claim 3, further comprising a feeding correction unit supported by the main support frame 110,
wherein the feeding correction unit comprises a first feeding correction unit 200 and a second feeding correction unit 210, and
the first feeding correction unit 200 comprises a first correction drive motor 202 mounted to the main support frame 110, a first rotating body 203 (lower cutter unit) coupled to the main support frame 110 via a first center hinge 208FCH, a first correction drive pulley 204 coaxially coupled to a motor shaft of the first correction drive motor 202, a first correction driven pulley 205 rotatably mounted to the first rotating body 203, a first correction belt 206 coupled to the first correction drive pulley 204 and the first correction driven pulley 205, a first correction ball screw 207 coaxially coupled to a center of the first correction driven pulley 205, a first correction ball screw nut 208 coupled to an outer peripheral surface of the first correction ball screw 207 and with an upper end coupled to the first rotating body 203 via a hinge, and a first vertical rotation shaft 209 that rotatably couples the first upper cutting support bracket 167 connected to the first cutting support bracket 122 supporting the first upper cutter 125 to the main support frame 110 in a horizontal direction, and the second feeding correction unit 210 comprises a second correction drive motor 212 mounted to the main support frame 110, a second rotating body 213 (lower cutter unit) coupled to the main support frame 110 via a second center hinge 208SCH, a second correction drive pulley 214 coaxially coupled to a motor shaft of the second correction drive motor 212, a second correction driven pulley 215 rotatably mounted to the second rotating body 213, a second correction belt 216 coupled to the second correction drive pulley 214 and the second correction driven pulley 215, a second correction ball screw 217 coaxially coupled to a center of the second correction driven pulley 215, a second correction ball screw nut 218 coupled to an outer peripheral surface of the second correction ball screw 217 and with an upper end coupled to the second rotating body 213 via a hinge, and a second vertical rotation shaft 219 that rotatably couples the second upper cutting support bracket 177 connected to the second cutting support bracket 132 supporting the second upper cutter 135 to the main support frame 110 in a horizontal direction.

6. The ultra-high-speed dual cutting system for secondary battery electrode plates according to claim 1, wherein the conveyor comprises a conveyor belt 152 that travels in an endless track on an electrode feeding line of the main support frame 110 such that the conveyor belt 152 travels in the endless track to feed the electrode plate, and the feeding roller 140 is disposed above the electrode plate and configured to feed the electrode plate together with the conveyor belt 152.

7. The ultra-high-speed dual cutting system for secondary battery electrode plates according to claim 6, wherein the conveyor belt 152 comprises a suction belt having a plurality of suction holes penetrating upper and lower surfaces.

8. The ultra-high-speed dual cutting system for secondary battery electrode plates according to claim 6, wherein a plurality of the conveyor belts 152 are arranged side by side in a left-right width direction of the main support frame 110.

9. The ultra-high-speed dual cutting system for secondary battery electrode plates according to claim 6,
wherein a plurality of the feeding rollers 140 are rotatably mounted to the main support frame 110 and arranged side by side in the left-right width direction of the main support frame 110, a feeding roller up-down drive motor 140UDM is mounted to the main support frame 110, a feeding roller up-down cam 140UDC is coupled to a motor shaft of the feeding roller up-down drive motor 140UDM, a feeding roller support frame 140RSF capable of lifting is coupled to the feeding roller up-down cam 140UDC and the main support frame 110, a plurality of guide rollers 143 are rotatably coupled to the feeding roller support frame 140RSF, an auxiliary feeding conveyor belt 140SCV traveling in an endless track is coupled to outer peripheral surfaces of the plurality of guide rollers 143, the auxiliary feeding conveyor belt 140SCV is coupled via an outer peripheral surface of an auxiliary feeding drive roller 140SCDR connected to a motor shaft of an auxiliary feeding belt drive motor 140SVM and outer peripheral surfaces of the plurality of guide rollers 143 in a vertically standing state, and is configured to travel in the endless track via the outer peripheral surfaces of the auxiliary feeding conveyor belt 140SCV and the plurality of guide rollers 143 according to driving of the auxiliary feeding belt drive motor 140SVM, a plurality of the feeding rollers 140 are coupled to the feeding roller support frame 140RSF via a roller shaft coupled at a center, the plurality of feeding rollers 140 are configured to be disposed above the feeding conveyor belt 152, and the feeding roller support frame 140RSF is provided with a plurality of tension rollers 144.

10. The ultra-high-speed dual cutting system for secondary battery electrode plates according to claim 2, further comprising a first cutting adhesion drive unit and a second cutting adhesion drive unit that closely contact the first upper cutter 125 and the second upper cutter 135 to the first lower cutter 126 and the second lower cutter 136, respectively, wherein the first cutting adhesion drive unit comprises a first cutting adhesion cylinder 223 mounted to the first cutting support bracket 122 with a cylinder rod disposed in a vertical direction, and a first cutter adhesion operation bracket 224 provided on the first cutting connection bracket 124 connected to the first cutting support bracket 122 via the first horizontal hinge 123 and disposed at a position capable of being pressed by the cylinder rod of the first cutting adhesion cylinder 223, and the second cutting adhesion drive unit comprises a second cutting adhesion cylinder 233 mounted to the second cutting support bracket 132 with a cylinder rod disposed in a horizontal direction, and a second cutter adhesion operation bracket 234 provided on the main support bracket and disposed at a position capable of being pressed by the cylinder rod of the second cutting adhesion cylinder 233.

11. An ultra-high-speed dual cutting method for secondary battery electrode plates using an ultra-high-speed dual cutting system for secondary battery electrode plates with a feeding correction function, comprising a dual cutter for cutting a secondary battery electrode plate, and a feeding roller 140 and a conveyor capable of feeding the electrode plate between the cutters during cutting of the electrode plate by the dual cutter, the method comprising:
an electrode feeding step of feeding the electrode plate to be cut along a feeding line by the feeding roller 140 and the conveyor, and
an electrode dual cutting step of cutting the electrode plate fed along the feeding line using the dual cutter.
